(19) United States
(12) Patent Application Publication
(10) Pub. No.: US 2011/0279237 A1
(43) Pub. Date: Nov. 17, 2011

(54) SECURING A DATA TRANSMISSION

(76) Inventors: Weng Wah Loh, Bristol (GB); Fraser John Dickin, Bristol (GB)

(21) Appl. No.: 13/146,946

(22) PCT Filed: Jan. 29, 2009
(86) PCT No.: PCT/EP09/51025

§ 371 Date: Jul. 29, 2011

(51) Int. Cl. G06K 7/01

(52) U.S. Cl. 340/10.1

(57) ABSTRACT

A method for securing a data transmission between a memory tag and a reader/writer device, the device operable to inductively power the tag in the near-field for data transmission using a near-field antenna of the device, comprising, generating an obfuscation signal in the device, and transmitting the obfuscation signal using a high gain far-field antenna of the device contemporaneously with a transmission of data to the powered tag using the near-field antenna, an interrogation device and a reader/writer device.

### BACKGROUND

In a close proximity radio-frequency (RF) ID type system, a reader/writer device is operable to transmit data to and read data from a memory of an inductively powered memory tag. To secure data written over-the-air to, and read over-the-air from a memory tag, data can encrypted at the source and decrypted at the recipient. There are numerous well documented cryptographic algorithms such as AES (the Advanced Encryption Standard) and DES (the Data Encryption Standard) providing ways to accomplish this.

Cryptographic primitives used in the formulation of a cryptographic solution are computationally intensive (and hence costly) to implement however, and, due to the nature of over-the-air transmissions in an RFID-type system, the encrypted transmissions are also subject to eavesdropping, which can lead to the transmission being compromised (for example, brute force methods can break the encryption over time allowing the data of the transmissions to be determined).

Furthermore, in a system in which tag real state is at premium not only for the reason that additional complexity at the chip level is costly to implement, but also because it is desirable to minimize the physical size of a tag due to constraints in the way in which the tag is to be used, the provision of an on-chip cryptographic engine which increases tag complexity and real estate is not desirable.

### BRIEF DESCRIPTION OF THE DRAWINGS

Various features and advantages of the present disclosure will be apparent from the detailed description which follows, taken in conjunction with the accompanying drawings, which together illustrate, by way of example only, features of the present disclosure, and wherein:

FIG. 1 is an embodiment of a memory tag;

FIG. 2 is an embodiment of circuitry of the memory tag of FIG. 1 and of a read/write device which is suitable for wireless communication with the memory tag of FIG. 1;

FIG. 3 is an embodiment of a secure data transfer system;

FIG. 4 is a flow diagram showing steps involved of one embodiment of a method for securing a transmission of data;

### DETAILED DESCRIPTION

In a near-field RFID-type system comprising a memory tag and a reader/writer or interrogator device, the device is operable to inductively power and interrogate the tag at distances of the order of 5 cm or less. According to an embodiment, the reader/writer device is operable to inductively power and interrogate the tag at distances of the order of 1 cm or less. An antenna used by the reader/writer device is adapted to be efficient in the near-field for data and power transfer, but is inefficient in the far-field.

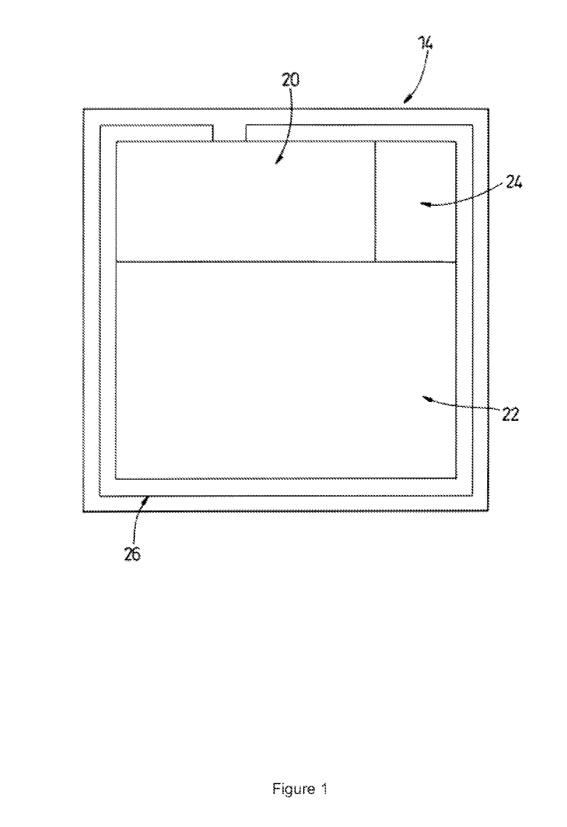

FIG. 1 of the accompanying drawings is a schematic representation of an embodiment for a memory tag. The memory tag 14 is provided on a chip, and comprises a transponder circuit 20, a memory 22, a power supply capacitor 24 and an antenna coil 26 having only a few turns, for example five or less. In an embodiment, the transponder circuit 20 operates at a frequency of approximately 2.45 GHz, and is of an area of approximately 0.5 mm². The antenna coil is suitable for and efficient in near-field communications between the tag and a suitable reader/writer device. The memory 22 provides of the order of 1 Mbit of capacity of non-volatile memory, and is of an area of approximately 1 mm², and uses FRAM (ferroelectric random access memory) or MRAM (magnetoresistive random access memory) or other similar memory technology requiring low power. In an embodiment, memory tag 14 is of a substantially square shape in plan view with an external dimension D for its sides of around 1 mm.

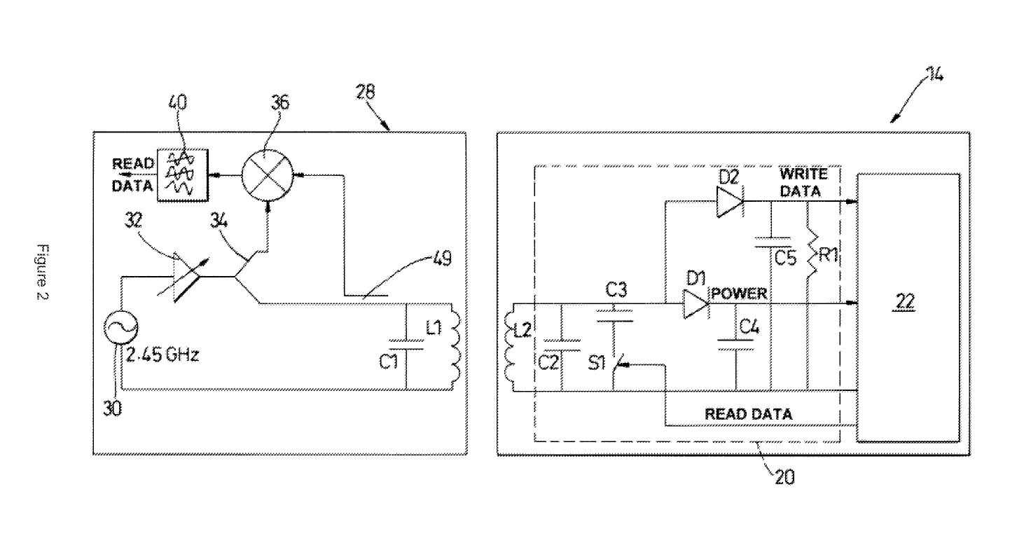

Referring to FIG. 2, the circuitry of a memory tag 14 and exemplary circuitry 28 of a read/write device (not shown) are illustrated schematically, using conventional component identifications (C-capacitor, L-inductance, R-resistor, D-diode and S-switch).

In an embodiment, the transponder circuit 20 of the memory tag 14 comprises a capacitor C2 which, in combination with the antenna coil L2 (26), forms a resonant circuit with component values being chosen to tune the combination to approximately 2.45 GHz for inductive coupling with a read/write device. The portion of transponder circuit 20 responsible for power supply is diode D1 and capacitor C4 (24), with diode D1 rectifying the alternating current generated by the inductive coupling and the capacitor C4 acting as a power supply storage unit.

The portion of the transponder circuit 20 responsible for receiving transmitted data from a read/write device is diode D2, capacitor C5 and resistor R1 which form a simple envelope detector; data thus received is stored in memory 22.

The portion of the transponder circuit 20 responsible for the reading of data from the memory 22 is the tuned circuit L2/C2 in combination with S1 and C3. Switching C3 in and out of the circuit using S1 changes the resonance of tuned circuit L2/C2 resulting in phase modulation of the reflected power from the memory tag 14 to a read/write device.

Circuit 28 is suitable for use in a read/write device and is operable to effect reading and writing of data to and from the memory tag 14. Read/Write circuit 28 comprises a signal generator 30 which generates a signal at a chosen frequency, for example 2.45 GHz. In order to transmit data to the tag 14, this signal passes via an amplitude modulator 32, where it is amplitude modulated with data to be written to the memory tag 14, and a splitter 34, to an antenna L1 and capacitor C1 which form a tuned circuit. The component values of L1 and C1 being chosen to tune it to 2.45 GHz, as for the tuned circuit in the memory tag 14, in order to maximise inductive coupling between the two circuits, and thus transmission of power and data to and from the memory tag 14.

Although the memory tag 14 described above operates at 2.45 GHz, it should be understood that memory tags operating at other frequencies can be used. Factors affecting the choice of operating frequency for the memory tags include: a) government regulations concerning radio frequency transmissions; b) adequate bandwidth (consistent with government regulations); c) frequency high enough to render the physical size of components in the memory tag small enough to keep the area of silicon required low (and hence the cost to manufacture low); d) frequency low enough to provide adequate performance when using low-cost high-volume CMOS technology to manufacture the memory tag.

A suitable read/write device comprises at least circuit 28, but can include additional functionality. For example, circuit 28 can be adapted for passing a data signal to a computer or other suitable device such as a mobile telephone, or PDA and the like which the read/write device 16 is connected to or otherwise part of, for subsequent data processing if desired.

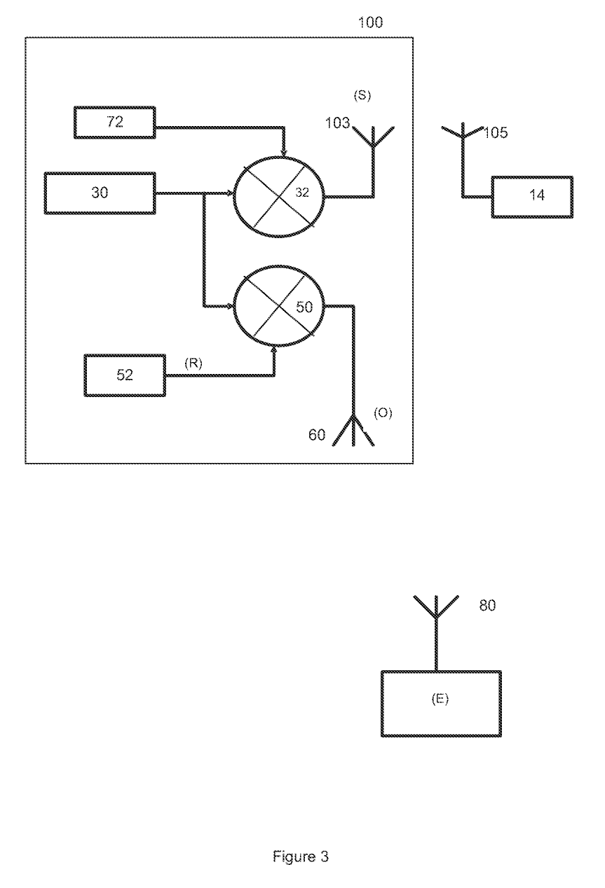

FIG. 3 is an embodiment of a secure data transfer system for use with a reader/writer circuit and memory tag such as those described above. A memory tag 14 and reader/writer system 100 communicate with one another using the near-field antennae 103, 105. Antenna 103 resides within the reader/writer circuit 100, whilst antenna 105 is an antenna for the memory tag 14, and can be an integral and/or a loop antenna as described above. Both antennae 103, 105 are designed for efficiency in the near-field region—that is to say, in a region no greater than approximately 1-50 mm from the antenna. It will therefore be appreciated that communication between tag 14 and a reader/writer device must occur within this range for effective powering of the tag, and hence for effective communication of data.

According to an embodiment, a portion of the carrier signal generated by generator 30 is tapped into a modulator 50. The tapped portion is modulated in modulator 50 with a non-deterministic (random) signal (R) from noise generator 52 to provide an output (O) to modulator 50. The output is fed into a high-gain far-field antenna 60 for transmission as an obfuscation signal. The obfuscation signal has the same frequency as an original signal (S) operable to carry data between the memory tag 14 and the reader/writer device, but is a signal which comprises merely noise with no discernable non-random content. The obfuscation signal, when transmitted contemporaneously with a data signal at substantially the same frequency, has the effect of disguising, obscuring or concealing the data signal from a potential eavesdropper with a suitable eavesdropping device tuned at the frequency of the data signal.

Original signal (S) is generated using the carrier signal modulated using modulator 32 with a data signal from the data signal generator 72. As the system is designed for close proximity communications, the original signal (S) used to provide power and transmit data to and from the tag 14 is many orders of magnitude greater in power than the obfuscation signal. As such, the obfuscation signal has a negligible effect on the normal operation of the memory tag communication system, and data transfer to/from the tag 14 is not adversely affected.

A potential eavesdropper (E) who is positioned of the order of several meters away from the system is only able to pick up the obfuscation signal transmitted by the high-gain far-field antenna (as the near-field antenna is not optimized for transmissions greater than a distance of the order of centimeters) using an antenna 80. In the event that an eavesdropper is able to pick up any part of the original signal (S), and since the obfuscation signal is transmitted at exactly the same frequency as the original data signal (S), any signal received by an eavesdropper in such circumstances is obfuscated by the obfuscation signal.

The result is that the transmission of data to and from tag 14 is secured since data carried by the original signal (S) cannot be determined by a potential eavesdropper as it has been obfuscated by the signal transmitted out of the far-field antenna 60 of the reader/writer device.

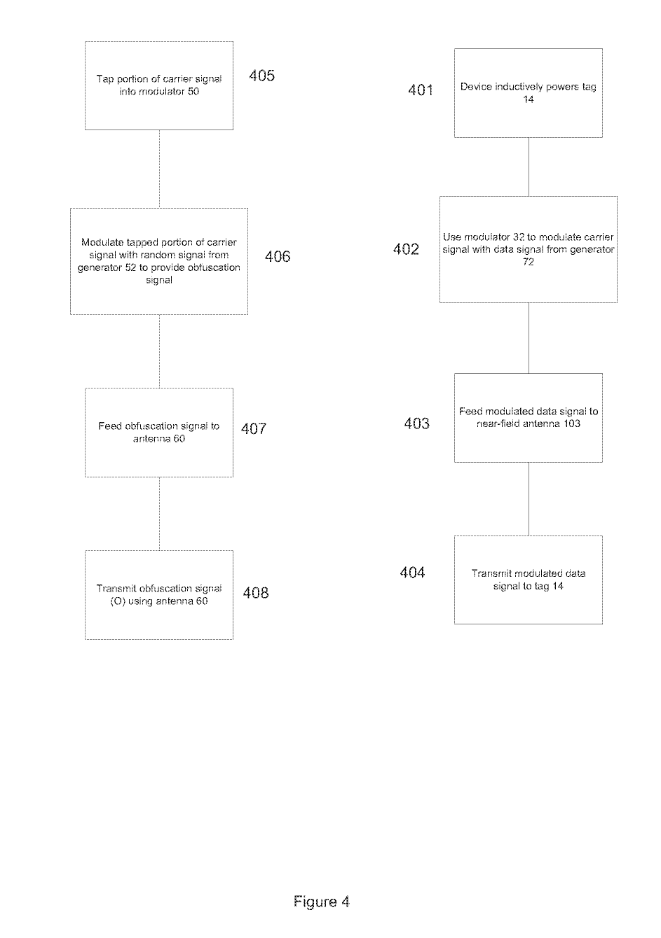

Referring to FIG. 4, which is a flow diagram showing steps involved in an embodiment of a method for securing a transmission of data, it can be seen that, at step 401 a reader/writer device operable to inductively power a memory tag, powers the tag using a near-field antenna which is also used by the reader/writer to write data to and read data from the tag.

For a tag operative at a radio frequency of approximately 2.45 GHz, the reader/writer device is operable to generate, using a signal generator, a carrier signal at said frequency.

At 402, the carrier signal is modulated using a modulator with a data signal from data signal generator 72, which data signal comprises a data stream which is to be written to a memory of the tag. The modulated data signal is fed to a near-field antenna 103 of the reader/writer device at 403 so that the modulated data signal can be sent to the memory tag 14 over an air interface using the near-field antenna at step 404. The modulated data signal is also operable to provide power to the tag by virtue of an inductive coupling between the reader/writer and the tag as has been described.

At step 405, a portion of the carrier signal generated in the reader/writer by the signal generator 30 is fed into a second modulator 50 of the device. The tapped portion of the carrier signal is modulated with a random, non-deterministic signal generated using a noise generator 52 of the reader/writer device in order to provide an obfuscation signal at 406.

At step 407, the obfuscation signal is fed to a far-field antenna 60 of the reader/writer device, which antenna is distinct from the near-field one used for communication with the memory tag. According to an embodiment, the far-field antenna is a high-gain, far-field antenna.

The obfuscation signal is transmitted by the far-field antenna 60 at 408. The transmission of the obfuscation signal occurs substantially contemporaneously with the transmission of the modulated data signal from the near-field antenna □ it will therefore be apparent that certain of the steps of FIG. 4 can occur concurrently within the system. For example the carrier signal is acted on substantially simultaneously by modulators 32 and 50 in order to provide their respective modulated signals.

Accordingly, data sent in the modulated data signal cannot be determined by an eavesdropper □ listening □ at the frequency in question because the modulated data signal is obfuscated at distances greater than the order of several centimeters, i.e. at the distances at which any potential eavesdropper could listen to the transmissions between the tag and the reader/writer device.

The system described above can be included as a stand alone system, i.e. as a reader/writer device which is operable to activate and interrogate a memory tag. Alternatively, the system can be implemented as part of another device. For example, the system, and more specifically the reader/writer device described, can be implemented within a device such as a mobile telephone, a PDA, a laptop computer or any other type of device where it is advantageous to incorporate the provision of secure data transmission to and from a memory tag.

It is to be understood that the above-referenced arrangements are illustrative of the application of the principles disclosed herein. It will be apparent to those of ordinary skill in the art that numerous modifications can be made without departing from the principles and concepts of this disclosure, as set forth in the claims below.

What is claimed is:

1. A method for securing a data transmission between a memory tag and a reader/writer device, the device operable to inductively power the tag in the near-field for data transmission using a near-field antenna of the device, comprising:
generating an obfuscation signal in the device; and
transmitting the obfuscation signal using a high gain far-field antenna of the device contemporaneously with a transmission of data for a powered tag using the near-field antenna.

2. A method as claimed in claim 1, wherein generating the obfuscation signal comprises:
modulating a portion of a carrier signal for the data transmission with a non-deterministic random signal.

3. A method as claimed in claim 1, wherein the near-field antenna is adapted to inductively power the tag within a range of 1-15 mm.

4. A method as claimed in claim 1, wherein the far-field antenna is adapted to transmit the obfuscation signal over a range greater than 1 m from the device such that the obfuscation signal does not interfere with the transmission of data for a powered tag.

5. An interrogation device adapted to inductively power a memory tag in the near-field using a near-field antenna of the device, the near-field antenna also used to read data from, and write data to a memory of the tag, the device comprising:
a carrier signal generator;
a noise generator; and
a modulator; the carrier signal generator operable to generate a carrier signal, a portion of which is modulated by the modulator with a random signal generated using the noise generator in order to provide an obfuscation signal for transmission using a far-field antenna of the device.

6. An interrogation device as claimed in claim 5, wherein the interrogation device is integral to a third party device.

7. An interrogation device as claimed in claim 5, wherein the far-field antenna is a high gain antenna adapted for transmission of the obfuscation signal over ranges greater than 1 m.

8. An interrogation device as claimed in claim 5, wherein the modulator is operable to generate the obfuscation signal at substantially the same time as the device reads data from or writes data to the tag.

9. A reader/writer device comprising a far-field antenna for the transmission of a jamming signal, wherein the jamming signal is generated in the device by modulating a portion of a carrier signal with random noise, the carrier signal used for inductively powering a memory tag using a near-field antenna of the device.

10. A reader/writer as claimed in claim 9, wherein the near-field antenna is also adapted for data transmission using a data signal, and wherein the power of the jamming signal in the region of the near-field antenna is an order of magnitude less than the power of the data signal.
